(19) United States
(12) Patent Application Publication
(10) Pub. No.: US 2023/0144030 A1
(43) Pub. Date: May 11, 2023

(54) MULTI-INPUT MULTI-OUTPUT ADDER AND OPERATING METHOD THEREOF

(71) Applicant: Industrial Technology Research Institute, Hsinchu (TW)

(72) Inventors: Chih-Wei Liu, Hsinchu County (TW); Yu-Chuan Li, Hsinchu City (TW)

(73) Assignee: Industrial Technology Research Institute, Hsinchu (TW)

(21) Appl. No.: 17/546,074

(22) Filed: Dec. 9, 2021

(30) Foreign Application Priority Data
Nov. 8, 2021 (TW) 110141536

(51) Int. Cl. G06F 7/50; G06F 7/523; G06F 7/483

(52) U.S. Cl. CPC G06F 7/50; G06F 7/523; G06F 7/483

(57) ABSTRACT

A multi-input multi-output adder and an operating method thereof are proposed. The multi-input multi-output adder includes an adder circuitry configured to perform an operation. The operation includes the following. A first source operand and a second source operand are added to generate a first summed operand. Direct truncation is performed on at least one last bit of the first summed operand to generate a first truncated-summed operand. Right shift is performed on the first truncated-summed operand to generate a first shifted-summed operand. A bit number of the right shift of the first truncated-summed operand is equal to a bit number of the direct truncation of the first summed operand.

### CROSS-REFERENCE TO RELATED APPLICATION

This application claims the priority benefit of Taiwan application serial no. 110141536, filed on Nov. 8, 2021. The entirety of the above-mentioned patent application is hereby incorporated by reference herein and made a part of this specification.

### TECHNICAL FIELD

The technical field relates to a multi-input multi-output adder and an operating method thereof.

### BACKGROUND

An n-bit floating-point multiplier requires much more chip area, computational speed, and power loss than an n-bit fixed-point multiplier, the biggest reason being the use of scientific notation for floating-point numbers. Therefore, after either multiplication or addition, the floating-point multiplier must perform a normalization and rounding step.

Brain floating-point format (BF16) is a new type of floating-point representation. Unlike half-precision floating-point format (FP16) and single-precision floating-point format (FP32), BF16 has a dynamic range comparable to that of FP32, has been widely used in convolutional neural network (CNN) applications because the 7-bit mantissa and the 1-bit sign bit match the 8-bit fixed point integer (INT-8) format.

On the other hand, in the field of CNN applications, since neural networks can allow for minor errors in computation, there is a growing trend in AI-on-Chip to support both BF16 and INT8 formats for both inference and training chips. Therefore, how to improve the slow speed, large area and energy consumption of floating-point multiplier, and how to improve the lack of precision and overflow of fixed-point multiplier are issues in this field.

### SUMMARY

One of exemplary embodiments provides a multi-input multi-output adder. The multi-input multi-output adder includes an adder circuitry. The adder circuitry is configured to perform an operation. The operation includes the following. A first source operand and a second source operand are added to generate a first summed operand. Direct truncation is performed on at least one last bit of the first summed operand to generate a first truncated-summed operand. Right shift is performed on the first truncated-summed operand to generate a first shifted-summed operand. A bit number of the right shift of the first truncated-summed operand is equal to a bit number of the direct truncation of the first summed operand.

One of exemplary embodiments provides a method operated by a multi-input multi-output adder. The method includes the following. A first source operand and a second source operand are added to generate a first summed operand. Direct truncation is performed on at least one last bit of the first summed operand to generate a first truncated-summed operand. Right shift is performed on the first truncated-summed operand to generate a first shifted-summed operand. A bit number of the right shift of the first truncated-summed operand is equal to a bit number of the direct truncation of the first summed operand.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate embodiments exemplary and, together with the description, serve to explain the principles of the disclosure.

FIG. 1 is a schematic diagram of an adder circuitry according to an exemplary embodiment of the disclosure.

FIG. 2 is a flowchart of an operating method of a multi-input multi-output adder according to an exemplary embodiment of the disclosure.

FIG. 3 is a schematic diagram of a multi-input multi-output adder according to an exemplary embodiment of the disclosure.

FIG. 4 is a schematic diagram of a forwarding adder network according to an exemplary embodiment of the disclosure.

FIG. 5 is a schematic diagram of a multi-input multi-output adder according to an exemplary embodiment of the disclosure.

FIG. 6 is a schematic diagram of a forwarding adder network according to an exemplary embodiment of the disclosure.

### DETAILED DESCRIPTION OF DISCLOSED EMBODIMENTS

Some of the exemplary embodiments of the disclosure will be described in detail with the accompanying drawings. The reference numerals used in the following description will be regarded as the same or similar components when the same reference numerals appear in different drawings. These exemplary embodiments are only a part of the disclosure, and do not disclose all of the ways in which this disclosure can be implemented. More specifically, these exemplary embodiments are only examples of the device and method in the claims of the disclosure.

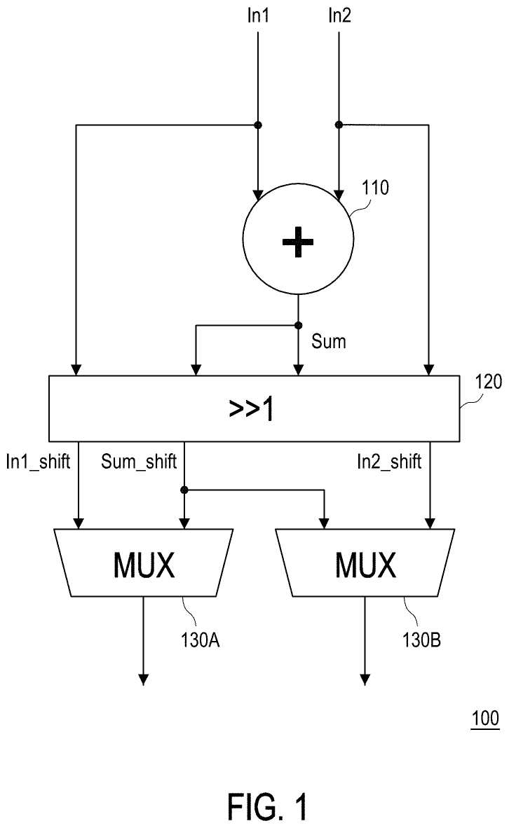

FIG. 1 is a schematic diagram of an adder circuitry according to an exemplary embodiment of the disclosure. FIG. 1 first introduces the various components of the system and the configuration relationship, and the detailed functions will be disclosed together with the flow chart of the subsequent example implementation.

Referring to FIG. 1, an adder circuit 100 of this exemplary embodiment is an adder tree with hierarchical structure, and may be composed of multiple adders, multiple shifters, and multiple multiplexers, but the disclosure is not limited thereto. Only one of an adder 110, a shifter 120, a multiplexer 130A, and a multiplexer 130B of one of levels are illustrated below. The adder 110 may be a two-input adder configured to receive two inputs In1 and In2 to perform an addition operation to generate a sum result Sum. The shifter 120 may be a one-bit right-shift operator to avoid overflow problems in a next level of the adder. In addition, in order to maintain flexibility, in a general adder tree, not every two inputs have to be added. Some steps only need to shift down or bypass the two inputs to a next level before doing necessary accumulation. Therefore, the multiplexer 130A may choose to output a sum result Sum_shift or directly output In1_shift. The multiplexer 130B may choose to output the sum result Sum_shift or directly output In2_shift. On the other hand, each of the levels of the adder has a multiplexer at a front end to select operands to be input.

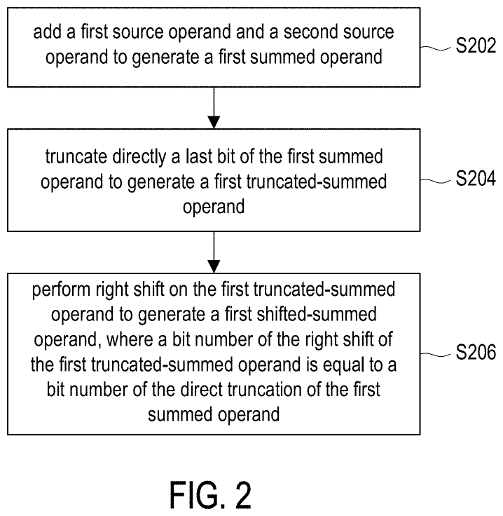

FIG. 2 is a flowchart of an operating method of a multi-input multi-output adder according to an exemplary embodiment of the disclosure, and method flow of FIG. 2 can be implemented by the adder circuitry 100 of FIG. 1.

Referring to FIG. 1 and FIG. 2 at the same time. The adder 110 of the adder circuitry 100 according to this exemplary embodiment first adds a first source operand and a second source operand to generate a first summed operand (step S202), and then direct truncates a last bit of the first summed operand to generate a first truncated-summed operand (step S204). After that, the shifter 120 performs right shift on the first truncated-summed operand to generate a first shifted-summed operand, where a bit number of the right shift of the first truncated-summed operand is equal to a bit number of the direct truncation of the first summed operand (step S206). In other words, according to this exemplary embodiment, the adder circuitry 100 may be implemented as a fixed-point direct truncation adder tree, which may improve the speed of operation and reduce power loss by direct truncation and shift of bits, while avoiding the error caused by overflow.

It should be noted that the structure is scalable, for example, by including N multipliers in a one-dimensional array, and connecting output ends of the N multipliers to the fixed-point direct truncation adder tree including (N−1) adders. In addition, a data path according to the exemplary embodiment is composed of a fixed-point operator, so a fixed-point multi-input multi-output multiplier is also supported. For the sake of clarity, the following is exemplary embodiments of 32 multipliers and 31 adders.

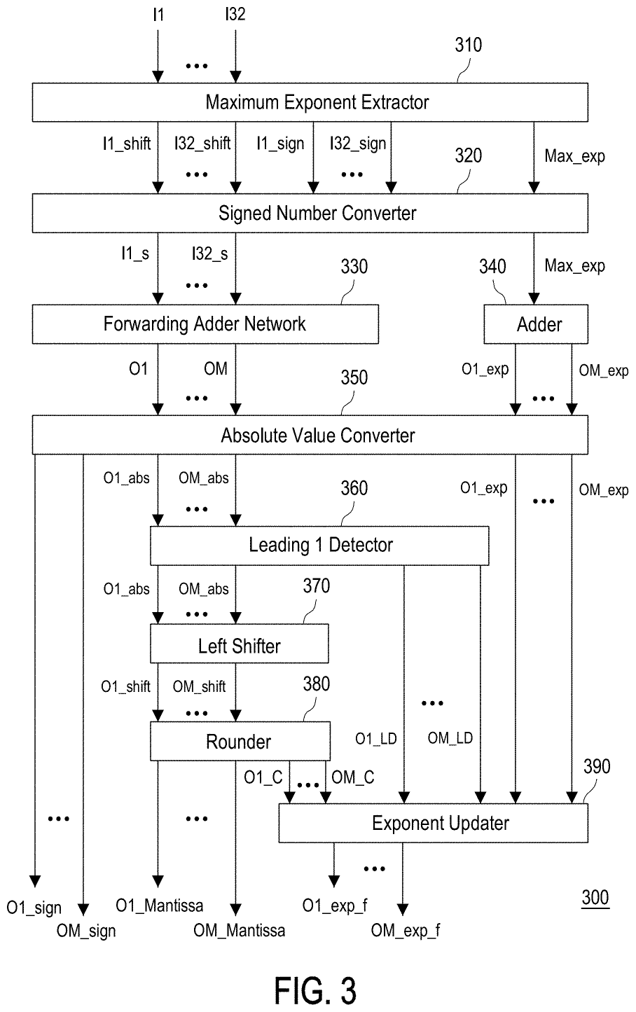

FIG. 3 is a schematic diagram of a multi-input multi-output adder according to an exemplary embodiment of the disclosure.

Referring to FIG. 3, according to this exemplary embodiment, it is assumed that there are 32 floating-point operands I1 to I32. First, all floating-point operands I1 to I32 are input from the 32 multipliers to a maximum exponent extractor 310 respectively. Next, the maximum exponent extractor 310 finds a maximum exponent Max_exp from exponent parts of the all floating-point operands I1 to I32, and then aligns exponents of remaining floating-point operands with the maximum exponent Max_exp, so that mantissas of the remaining floating-point are shifted to the right. A bit number of the shift of each of the remaining floating-point operands is a difference value between an exponent of the each of the remaining floating-point operands and the maximum exponent Max_exp.

It is assumed that mantissas that have completed extraction of the maximum exponent are respectively I1_shift to I32_shift. Next, a signed number converter 320 performs signed number conversion according to respective symbols I1_sign to I32_sign of the floating-point operands I1˜I32, and converted positive and negative mantissas are expressed as two's complements, i.e., I1_s to I32_s. After that, the mantissas I1_s to I32_s that have completed the extraction of the maximum exponent and the signed number conversion are entered into a forwarding adder network 330 for addition operation, and a structure of the forwarding adder network 330 will be explained later.

In order to maximize the multi-input multi-output multiplier, it is assumed that the forwarding adder network 330 may output M forwarding adder network results O1 to OM. According to this exemplary embodiment, in order to make the output results meet BF16 format, an absolute value converter 350 first keeps symbols of the forwarding adder network results O1 to OM, so as to convert the forwarding adder network results O1 to OM to unsigned number results O1_abs to OM_abs, and output symbolic bits O1_sign to OM_sign of the forwarding adder network results O1 to OM.

Then, it moves on to normalization step. Here, a leading 1 detector 360 first detects starting bit positions O1_LD to OM_LD of the first 1 of the unsigned number results O1_abs to OM_abs, and then a left shifter 370 shifts the unsigned number results O1_abs to OM_abs to the left to a most significant bit of 1 to generate normalization results O1_shift to OM_shift.

After that, it moves on to rounding step. Here, a rounder 380 rounds the normalization results O1_shift to OM_shift to adjust to a mantissa bit number of a target floating-point format, so as to generate results O1_Mantissa to OM_Mantissa, and rounded rounding is O1_C to OM_C.

On the other hand, an adder 340 adds Max_exp to a number of levels of the forwarding adder network 330 through which each of the results O1 to OM passes, i.e., exponents O1_exp to OM_exp of the forwarding adder network results O1 to OM.

Finally, an exponent updater 390 determines exponents O1_exp_f to OM_exp_f of each of the output results according to the positions of leading 1 O1_LD to OM_LD, the rounding O1_C to OM_C, and the exponents O1_exp to OM_exp. O1_exp_f=O1_exp+O1_C+(O1_LD-BW), where BW is a fractional digit of O1_abs.

In order to keep all significant digits (full-precision), traditional forwarding adder networks usually utilize adders with different bit numbers at different levels. Taking a forwarding adder network with 32 operands as an example, structurally, it can be divided into 5 levels. A first level uses an n-bit adder, a second level uses an (n+1)-bit adder, a third level uses an (n+2)-bit adder, and so on. Taking a forwarding adder network with 32 operands as an example, each level increases by one bit, so 5 levels increase by a total of 5 bits, resulting in a longer critical path in the structure. As a result, the traditional forwarding adder network structure significantly increases an chip area due to the increase in the number of input bits (e.g. 512 and 1024), and the too-long critical path of the adder slows down the chip speed and consume too much power. Based on this, the following is a framework that may effectively solve the above problem for implementation in the forwarding adder network 330.

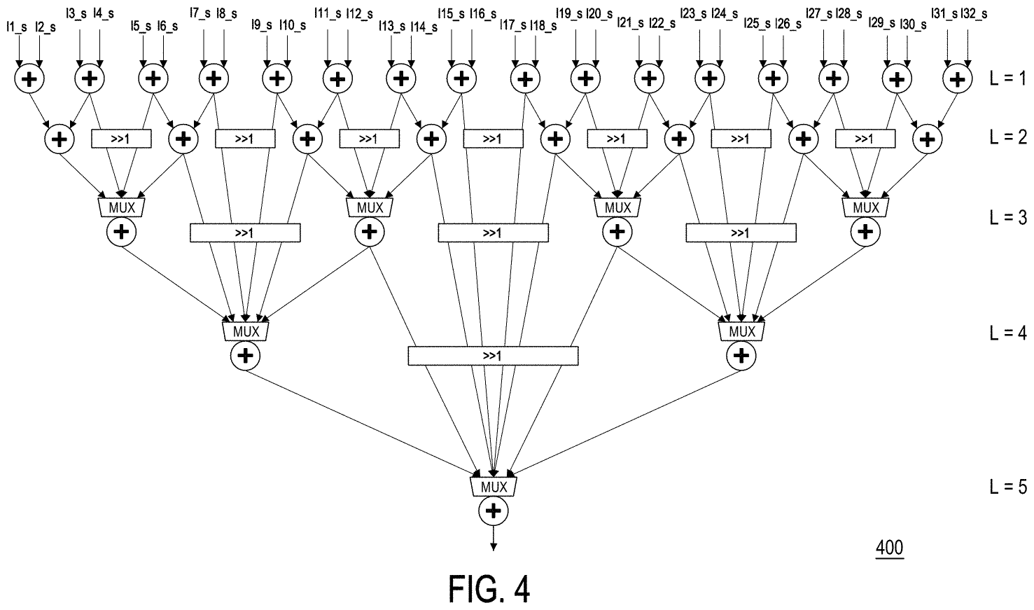

FIG. 4 is a schematic diagram of a forwarding adder network according to an exemplary embodiment of the disclosure.

Referring to FIG. 4, according to this exemplary embodiment, a forwarding adder network 400 receives the floating-point operands I1_s to I32_s in FIG. 3, and each of level L is a direct truncation adder using a same bit number n-bit. To avoid overflow, a 1-bit shifter may be inserted after each n-bit direct truncation adder. In other words, a bit number at an input end and a bit number at an output end of the each n-bit direct truncation adder are both n-bit. After the two n-bit operands are added, the n-bit direct truncation adder directly deletes a last bit of a sum result and shifts the result one bit to the right. That is, output of the n-bit direct truncation adder of a first level (L=1) is input of the n-bit direct truncation adder of a second level (L=2), and so on. In this way, a structure of the forwarding adder network 400 may ensure that there will be no overflow errors during the computation phase. In addition, since the bit number in each level is the same, the result will be shifted to the right by one bit and truncated to an original bit number after adding, so that the same bit number in the each of level L may be maintained. In order to avoid a situation that mantissas of a same level in the forwarding adder network have different exponents and cannot be added directly, even mantissas that are not added are shifted to the right by one bit when they are sent down to the next level, so that the exponents of the same level are all the same.

On the whole, before entering the forwarding adder network, the floating-point operands first go through maximum exponent extraction to align mantissas, and make exponents of all operands the same before they can enter the forwarding adder network to be added together. A forwarding adder network with five levels and a 16-bit mantissa is taken as an example. If the maximum exponent extraction is for 32 operands, a maximum exponent of the 32 operands is found, and exponents of remaining 31 operands are aligned with the maximum exponent. The worst case is that a difference between the maximum exponent and the exponents of the remaining 31 operands is more than 16, and all the operands have to be added together. In order to align the remaining 31 operands with the maximum exponent, the mantissas are shifted to the right until an original maximum full-precision exceeds an original bit number, thus causing the mantissas of the remaining 31 operands with smaller exponents to be shifted to 0, resulting in an error. If the exponent is 8 bits, assuming that an operand with the maximum exponent is 1.0₂×2⁻¹¹⁰, the remaining 31 operands are all:

1.111111111111111₂×2⁻¹²⁶=1.999969482421875₁₀×2⁻¹²⁶.

The correct result in this case should be:

1.0₁₀×2⁻¹¹⁰+31×1.999969482421875₁₀×2⁻¹²⁶=1.000946030486375₁₀×2⁻¹¹⁰.

However, after the designed adder tree, the result is:

1.0₁₀×2⁻¹¹⁰+31×0₁₀×2⁻¹¹⁰.

In this way, a resulting error is 0.00094514, and a SQNR is about 60 dB.

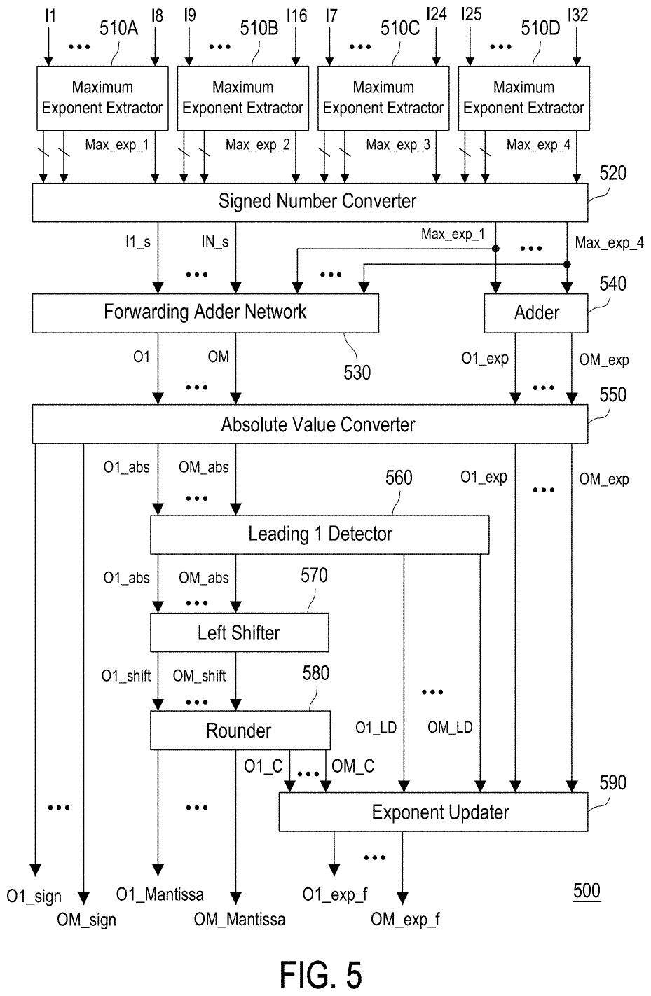

To further improve accuracy of the operation, FIG. 5 is a schematic diagram of a multi-input multi-output adder according to an exemplary embodiment of the disclosure. Referring to FIG. 5, according to this exemplary embodiment, if there are 32 floating-point operands I1 to I32, they will be divided into four groups I1 to I8, I9 to I16, I17 to I24, and I25 to I32. Maximum exponent extractors 510A to 510B perform extraction of a maximum exponent for each group to extract Max_exp_1 to Max_exp_4 respectively. For the operation of a signed number converter 520, a forwarding adder network 530, an adder 540, an absolute value converter 550, a leading 1 detector 560, a left shifter 570, a rounding 580, and an exponent updater 590, please refer to the signed number converter 320, the forwarding adder network 330, the adder 340, the absolute value converter 350, the leading 1 detector 360, the left shifter 370, the rounding 380, and the exponent updater 390, and therefore will not be repeated in the following.

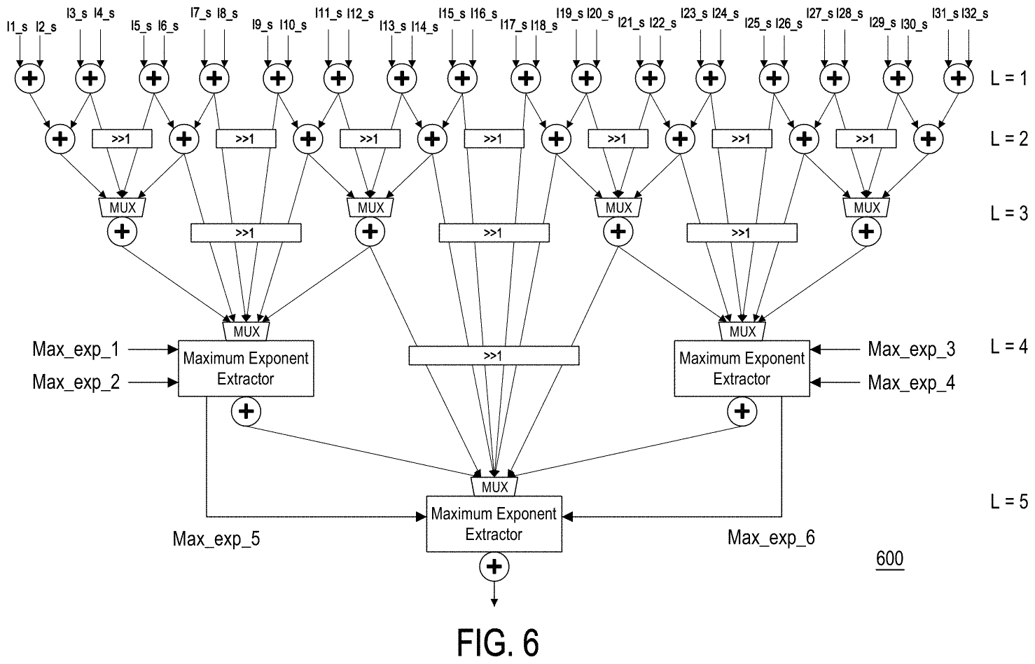

It should be noted that a structure of the forwarding adder network 530 can be implemented as shown in FIG. 6, which is a schematic diagram of a forwarding adder network according to an exemplary embodiment of the disclosure.

Referring to FIG. 6, in a fourth level (L=4) of a forwarding adder network 600, an adder encounters different exponents on the left and right. Therefore, it is necessary to compare Max_exp_1 with Max_exp_2 and Max_exp_3 with Max_exp_4 respectively, shift a mantissa with a smaller exponent to the right to align with the other side, and output the larger exponent of Max_exp_1 and Max_exp_2 as Max_exp_5, and the larger exponent of Max_exp_3 and Max_exp_4 as Max_exp_6. At a fifth level (L=5), it is necessary to compare Max_exp_5 and Max_exp_6, and shift the mantissa with the smaller exponent to the right, and finally finish the result, and the result is finally completed. At this time, in the original worst case, only one group is shifted to the right to 0, and the result is:

1.0₁₀×2⁻¹¹⁰+4×0₁₀×2⁻¹¹⁰+28×1.999969482421875₁₀×2⁻¹¹⁰.

In this way, a resulting error is 0.000091465, which is 90% less than the previous extraction of the maximum exponent of the 32 floating-point operands without 32 floating-point operands, and the SQNR is about 80.4 dB.

Based on this, in terms of application, in order to simplify the operation of a BF16 multiplier, the multi-input multi-output multiplier may support both BF16 and INT8 formats. In the structure, N BF16 multipliers may be arranged in a one-dimensional array, and an adder tree including (N−1) 16-bit adders is connected to output ends of the N BF16 multipliers. In order to improve the hardware speed, the normalization and rounding steps required in each BF16 floating-point multiplier are removed from the calculation process, and only the normalization and rounding steps of the last level of the adder are retained. In this way, inputs and outputs of the multi-input multi-output multiplier tree may maintain a BF16 floating-point format, while the intermediate calculation process is realized by a fixed-point 16-bit direct truncation adder. In addition, in the fixed-point 16-bit direct truncation adder tree, a 1-bit shifter may be inserted in a fixed-point 16-bit direct truncation adder tree, which not only improves accuracy of the operation, but also avoids overflow of the fixed-point direct truncation adder.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A multi-input multi-output adder comprising:
an adder circuitry configured to perform an operation, wherein the operation comprises:
adding a first source operand and a second source operand to generate a first summed operand;
performing direct truncation on at least one last bit of the first summed operand to generate a first truncated-summed operand; and
performing right shift on the first truncated-summed operand to generate a first shifted-summed operand, wherein a bit number of the right shift of the first truncated-summed operand is equal to a bit number of the direct truncation of the first summed operand.

2. The multi-input multi-output adder according to claim 1, wherein the adder circuitry is an adder tree.

3. The multi-input multi-output adder according to claim 2, wherein the adder tree comprises a plurality of adders, wherein each of the adders is a direct truncation adder with a same number of bits.

4. The multi-input multi-output adder according to claim 3, wherein the adder tree further comprises a plurality of shifters.

5. The multi-input multi-output adder according to claim 4, wherein the adder comprises a first adder, and the shifter comprises a first shifter, wherein the first adder direct truncates a last bit of the first summed operand to generate the first truncated-summed operand, wherein the first shifter shifts the first truncated-summed operand to the right by one bit number to generate the first shifted-summed operand.

6. The multi-input multi-output adder according to claim 2 further comprising:
N multipliers, wherein an output end of each of the multipliers is connected to the adder tree.

7. The multi-input multi-output adder according to claim 1 further comprising:
at least one maximum exponent extractor configured to:
receive a plurality of floating-point operands;
determine a first floating-point operand with a largest exponent from the floating-point operands;
align an exponent of each of remaining floating-point operands of the floating-point operands with the largest exponent of the first floating-point operand, such that a mantissa of the each of the remaining floating-point operands is performed right shift to generate a plurality of maximum exponent extraction mantissas; and
calculate the first source operand and the second source operand according to the maximum exponent extraction mantissas.

8. The multi-input multi-output adder according to claim 7, wherein a bit number of the right shift of the mantissa of the each of the remaining floating-point operands is a difference value between the exponent of the remaining floating-point operands and the maximum exponent, respectively.

9. The multi-input multi-output adder according to claim 7, wherein when a number of the maximum exponent extractor is multiple, the floating-point operands received by each of the maximum exponent extractors are a plurality of floating-point operands after clustering.

10. The multi-input multi-output adder according to claim 7 further comprising:
a signed number converter configured to:
perform signed number conversion according to a symbol of each of the floating-point operands to generate signed number conversion mantissas, respectively, wherein the first source operand and the second source operand are two of the signed number conversion mantissas.

11. The multi-input multi-output adder according to claim 1 further comprising:
an absolute value converter configured to:
retain a plurality of symbols of a plurality of output results of the adder circuitry to convert each of the output results to an unsigned number to generate a plurality of unsigned number results; and
output the symbols.

12. The multi-input multi-output adder according to claim 11 further comprising:
a leading 1 detector configured to detect a starting bit position of a first 1 of each of the unsigned number results; and
a left shifter configured to shift the each of the unsigned number results to the left to a most significant bit of 1 to generate a normalization result.

13. The multi-input multi-output adder according to claim 12 further comprising:
a rounder configured to round each of the normalization result to adjust to a mantissa bit number of a target floating-point format.

14. The multi-input multi-output adder according to claim 1, wherein inputs and outputs of the adder circuitry are in floating-point format.

15. The multi-input multi-output adder according to claim 1, wherein inputs and outputs of the adder circuitry are in fixed-point format.

16. A method operated by a multi-input multi-output adder comprising:
adding a first source operand and a second source operand to generate a first summed operand;
performing direct truncation on at least one last bit of the first summed operand to generate a first truncated-summed operand; and
performing right shift on the first truncated-summed operand to generate a first shifted-summed operand, wherein a bit number of the right shift of the first truncated-summed operand is equal to a bit number of the direct truncation of the first summed operand.
